(19) United States
(12) Patent Application Publication
(10) Pub. No.: US 2022/0260993 A1
(43) Pub. Date: Aug. 18, 2022

(54) Vehicle Control Systems And Methods

(71) Applicant: Ford Global Technologies, LLC, Dearborn, MI (US)

(72) Inventors: Erick Lavoie, Van Buren Charter Township, MI (US); Hemanth Yadav Aradhyula, Farmington Hills, MI (US)

(73) Assignee: Ford Global Technologies, LLC, Dearborn, MI (US)

(21) Appl. No.: 17/176,690

(22) Filed: Feb. 16, 2021

(51) Int. Cl. G05D 1/00; B60W 30/06; G06N 20/00; G06N 5/04

(52) U.S. Cl. CPC G05D 1/0038; B60W 30/06; G06N 20/00; B60W 2556/60; B60W 2555/20; B60W 2420/42; G06N 5/04

(57) ABSTRACT

The present disclosure generally relates to vehicle remote parking assistance, and, more specifically, systems and methods for determining a distance between a vehicle and a mobile device during a remote parking procedure. In particular, the systems and methods relate to determining a noise factor and remedy to eliminate the noise factor to be able to use a first method to determine the distance. The first method is based on an image of a vehicle from a camera of a mobile device and a digital model of the vehicle.

### BACKGROUND

Vehicles may include the ability to remotely drive themselves with no or only minor control from a user. Some vehicles may be able to park themselves while an owner or driver watches from outside the vehicle and provides no or minimal motion control. In these instances, the driver may initiate the remote parking operation from a handheld computing device in communication with the vehicle. The computing device may thus be able to control one or more aspects of the vehicle remotely.

In these cases of remote control of the vehicle, the user may be required to remain within a certain distance of the vehicle while controlling the vehicle. Some states, countries, or other jurisdictions may require that a driver be within a threshold distance from the vehicle in order to allow this remote parking feature to take place. For instance, a regulation or law may require a driver to be within 10 meters of the vehicle during operation of the remote parking feature, and may require that the vehicle stop if the driver is too far away.

It is with respect to these and other considerations that the disclosure made herein is presented.

### DESCRIPTION OF THE FIGURES

The detailed description is set, forth with reference to the accompanying drawings. The use of the same reference numerals may indicate similar or identical items. Various embodiments may utilize elements and/or components other than those illustrated in the drawings, and some elements and/or components may not be present n various embodiments. Elements and/or components in the figures are not necessarily drawn to scale. Throughout this disclosure, depending on the context, singular and plural terminology may be used interchangeably.

FIG. 1 depicts a vehicle control system for controlling a vehicle with a mobile device in accordance with the present disclosure.

FIG. 2 is a schematic illustration of a noise factor model in accordance with the present disclosure.

FIG. 3 is a flow chart of an exemplary method in accordance with the present disclosure.

FIG. 4 depicts the vehicle control system of FIG. 1 accordance with the present disclosure.

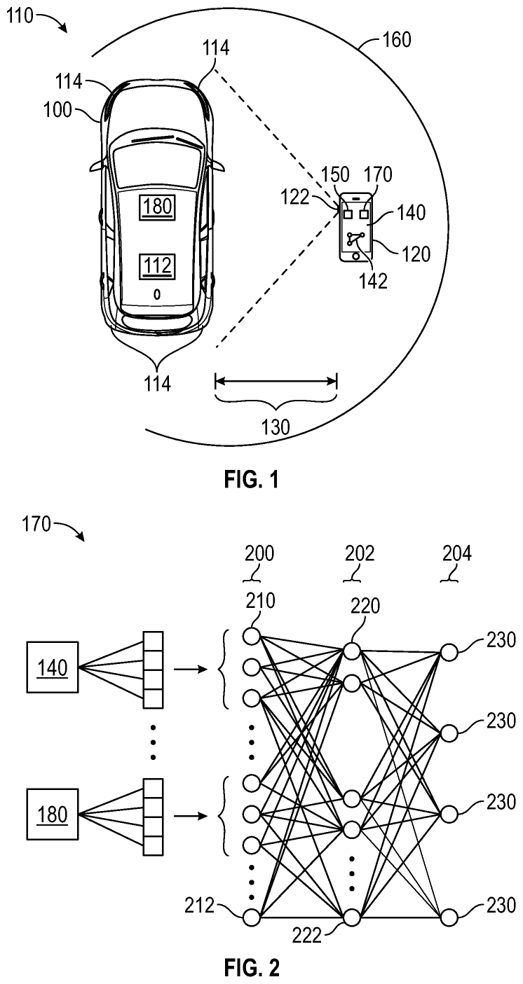

### DETAILED DESCRIPTION

### Overview

The present disclosure generally relates to remote driver assist technologies (ReDAT), including vehicle remote parking assistance (RePA), and, more specifically, systems and methods for determining a distance between a vehicle and a mobile device during a remote parking procedure. In particular, the systems and methods relate to determining a noise factor and remedy to eliminate the noise factor to be able to use a first method to determine the distance. The first method is based on an image of a vehicle from a camera of a mobile device and a digital model of the vehicle.

An exemplary vehicle control system 110 includes a vehicle 100 (including a vehicle computer 112 and marker features 114) and a mobile device 120 (including a camera 122). The vehicle control system 110 is configured to determine a distance 130 between the vehicle 100 and the mobile device 120 during a remote parking procedure.

A first method of determining the distance 130 is based on an image 140 of the vehicle 100 from the camera 122 of the mobile device 120 and a 3D model 142 of the vehicle 100. The vehicle 100 may transmit the 3D model 142 of the vehicle 100 to the mobile device 120. The mobile device 120 is configured to receive the 3D model 142, capture an image 140 of the vehicle 100, and determine a distance 130 between the mobile device 120 and vehicle 100 based on the image 140 and the 3D model 142.

The distance 130 may be compared to a threshold distance 160 (e.g., 6 meters) that determines if the vehicle control system 110 can be used to control the vehicle 100. For example, if the calculated distance 130 is greater than the threshold distance 160, control with the mobile device 120 is disabled until the distance 130 is less than the threshold distance 130.

The distance 130 may be unable to be determined based on the image 140 and the 3D model 142 as noise factors may distort the image 140. For example, noise factors may include snow on the vehicle 100, reflection of light off the vehicle 100 at a lens of the camera 122, active rain fall, snow fog, low natural light (e.g., night).

If the distance 130 is unable to be determined based on the image 140 and the 3D model 142, the mobile device 120 performs noise factor detection on the image 140 to determine a noise factor. The noise factor may be determined according to a noise factor model 170. The noise factor model 170 may be a machine learning model that is trained on various noise factors. In particular, the machine learning model may be trained on images that are labeled with a noise factor classification.

The machine learning model may be additionally trained on sensor data or information from sensors 180 (e.g., on the vehicle 100 and/or mobile device 120). The sensors 180 may include a camera, global positioning system (GPS), temperature sensors, a barometer, and the like. The machine learning model may also be trained on data collected by the vehicle computer 112 and/or the mobile device 120 including weather data from weather stations, and the like.

For certain noise factor classifications, one or more remedies may he provided. For example, a remedy may include an action for a user to perform to eliminate the noise factor from the image 140. Based on a noise factor classification of the machine learning model, the mobile device 120 may determine if there is a remedy associated with the noise factor. If there is a remedy, the mobile device 120 provides the remedy to a user interface of the mobile device 120 to indicate to the user what action to perform to try to eliminate the noise factor. For example, if the noise factor classification is snow, the mobile device 120 provides a remedy that includes brushing the snow off the vehicle 100. If the noise factor is reflection of light, the mobile device 120 provides a message to move to a different location. After the suggested action is performed by the user, the mobile device 120 again attempts to determine the distance 130 based on the image 140 and the 3D model 142.

If the noise factor does not include an associated remedy (e.g., fog) or the noise factor cannot be eliminated with the suggested remedy, the mobile device 120 determines the distance 130 according to a second method. For example, the second method can include using an image from a vehicle camera (e.g., imaging techniques to detect face, posture, phone), a strength of a wireless connection between the vehicle 100 and the mobile device 120 (e.g., Bluetooth or Wi-Fi), low frequency (LF) antennas to triangulate the position of a LE key fob, determining the distance based on a calculated trajectory of the vehicle 100 and a calculated trajectory of the mobile device 120, combinations thereof, and the like.

These and other advantages of the present disclosure are provided in greater detail herein.

### Illustrative Embodiments

The disclosure will be described more fully hereinafter with reference to accompanying drawings, in which exemplary embodiments of the disclosure are shown, and not intended to be limiting.

The vehicle control system 110 includes the vehicle 100 and the mobile device 120. The vehicle 100 includes the vehicle computer 112, marker features 114, and sensors 180. The mobile device 120 includes the camera 122.

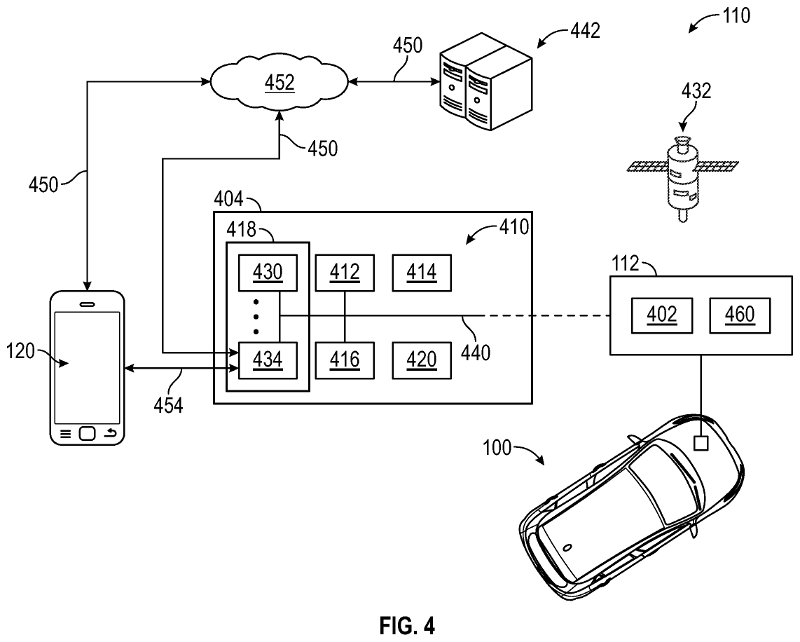

The vehicle control system 110 is described in further detail with respect to FIG. 4.

The vehicle 100 may take the form of another passenger or commercial automobile such as, for example, a truck, a car, a sport utility vehicle, a crossover vehicle, a van, a minivan, a taxi, a bus, etc., and may be configured to include various types of automotive drive systems. Example drive systems can include various types of internal combustion engine (ICE) powertrains having a gasoline, diesel, or natural gas-powered combustion engine with conventional drive components such as, a transmission, a drive shaft, a differential, etc.

In another configuration, the vehicle 100 may be configured as an electric vehicle (EV). More particularly, the vehicle 100 may include a battery EV (BEV) drive system. The vehicle 100 may be configured as a hybrid EV (HEV) having an independent onboard power plant or a plug-in HEV (PHEV) that includes a HEV powertrain connectable to an external power source (including a parallel or series hybrid powertrain having a combustion engine power plant and one or more EV drive systems). HEVs can include battery and/or super capacitor banks for power storage, flywheel power storage systems, or other power generation and storage infrastructure.

The vehicle 100 may be further configured as a fuel cell vehicle (FCV) that converts liquid or solid fuel to usable power using a fuel cell, (e.g., a hydrogen fuel cell vehicle (HFCV) powertrain, etc.) and/or any combination of these drive systems and components.

Further, the vehicle 100 may be a manually driven vehicle, and/or be configured to operate in a fully autonomous (e.g., driverless) mode (e.g., level-5 autonomy) or in one or more partial autonomy modes. Examples of partial autonomy modes are widely understood in the art as autonomy Levels 1 through 5.

An autonomous vehicle (AV) having Level 1 autonomy may generally include a single automated driver assistance feature, such as steering or acceleration assistance. Adaptive cruise control is one such example of a Level-1 autonomous system that includes aspects of both acceleration and steering.

Level-2 autonomy in vehicles may provide partial automation of steering and acceleration functionality, where the automated system(s) are supervised by a human driver that performs non-automated operations such as braking and other controls.

Level-3 autonomy in a vehicle can generally provide conditional automation and control of driving features. For example, Level-3 vehicle autonomy typically includes “environmental detection” capabilities, where the vehicle can make informed decisions independently from a present driver, such as accelerating past a slow-moving vehicle, while the present driver remains ready to retake control of the vehicle if the system is unable to execute the task.

Level 4 autonomy includes vehicles having high levels of autonomy that can operate independently from a human driver, but still include human controls for override operation. Level-4 automation may also enable a self-driving mode to intervene responsive to a predefined conditional trigger, such as a road hazard or a system failure.

Level 5 autonomy is associated with autonomous vehicle systems that require no human input for operation, and generally do not include human operational driving controls.

The sensors 180 on the vehicle 100 (and/or mobile device 120) may include a camera, global positioning system (UPS), temperature sensors, a barometer, inertial sensors, a RADAR and/or LIDAR, combinations thereof, and the like.

Inertial sensors 180 may be configured to detect a location, speed, and heading of vehicle 100 and/or mobile device 120. Inertial sensors may include accelerometers, gyroscopes, wheel speed sensors, compasses or directional sensors, combinations thereof, and the like. Other sensors include those that may be electrically coupled to the vehicle computer 112 or mobile device 120 such that information can be transmitted and received. For example, data collected by the vehicle computer 112 and/or the mobile device 120 may include weather data from weather stations, and the like.

The vehicle control system 110 is configured to determine a distance 130 between the vehicle 100 and the mobile device 120 during a remote parking procedure. The distance 130 may be compared to the threshold distance 160 (e.g., 6 meters). The threshold distance 160 determines a maximum distance at which the vehicle control system 110 can be used to control the vehicle 100. For example, if the distance 130 is greater than the threshold distance 160, control of the vehicle 100 with the mobile device 120 is disabled until the distance 130 is less than the threshold distance 160.

A first method of determining the distance 130 is based on an image 140 of the vehicle 100 from the camera 122 of the mobile device 120 and the 3D model 142 of the vehicle 100. The vehicle 100 may transmit the 3D model 142 of the vehicle 100 to the mobile device 120. The mobile device 120 is configured to receive the 3D model 142, capture an image 140 of the vehicle 100, and determine a distance 130 between the mobile device 120 and vehicle 100 based on the image 140 and the 3D model 142.

In particular, the vehicle 100 may include marker features 114 (e.g., lights) at marker locations. Each marker location on the vehicle 100 is associated with a coordinate of a vehicle coordinate system such that the marker locations, and distances and spatial relationships between the marker features 114, are known.

Each marker feature 114 includes a unique pattern and/or other marker characteristics that are configured to be detected by image processing, pattern recognition, and/or other computer vision techniques. The marker feature 114 can be read to access associated marker information such as a name of the marker feature 114, the marker location, and spatial relationships (e.g., distances to, directions to) with other markers features 114.

The mobile device 120 includes a mobile device computer (e.g., as described with respect to vehicle computer 112), a touchscreen display, and the camera 122. The mobile device computer includes a memory and a processor. Broadly, the mobile device 120 is configured to interact with the vehicle 100.

The camera 122 is configured to capture the camera image 140 (e.g., image data) of the vehicle 100 and the marker features 114. The mobile device 120 is configured to determine an image location of each marker feature 114 in the camera image 140 on a screen coordinate system.

The mobile device 120 includes a computer vision application that is configured to perform image processing, pattern recognition, and/or other computer vision techniques to read the marker features 114 in the camera image 140 and obtain the marker locations of each marker feature 114 from the associated marker information

The mobile device 120 determines a transformation matrix (e.g., a camera model) that elates the image locations marker feature 114 in the camera image 140 and the marker location of the marker feature 114. The transformation matrix reflects the pose of the camera 122 including the location and the orientation of the camera 122.

The orientation of the camera 122 can be expressed as a rotation matrix (e.g., as rotation angles). The location of the camera 122 can be expressed by a translation vector. The transformation matrix may also include camera-specific adjustments such as for focal length, image sensor orientation, and size.

As the image locations of marker features 114 are known (e.g., determined from the camera image 140) and the marker locations of the marker features 114 are known (e.g., the marker location is accessed from the marker information), the elements of the transformation matrix may be determined, for example, using an iterative optimization method. A pose of the camera 122, including the orientation and location of the camera 122, can be determined from the elements of the transformation matrix.

The distance 130 can be determined from the location of the camera 122.

A second method of determining the distance 130 may be based on using an image from a camera of the vehicle 100 (e.g., imaging techniques to detect face, posture, the mobile device 120), a strength of a wireless a connection between the vehicle 100 and the mobile device 120 (e.g., Bluetooth or Wi-Fi), low frequency (LF) antennas to triangulate the position of a LF key fob or the mobile device 120, based on a calculated trajectory of the vehicle 100 and a calculated trajectory of the mobile device 120, combinations thereof, and the like.

The distance 130 may be updated over time based on a calculated trajectory of the vehicle 100 and a calculated trajectory of the mobile device 120. The trajectory of the vehicle 100 may be determined based on a kinematic model and/or data from sensors 180 (e.g., vehicle inertial data 150 may be transmitted from the vehicle 100 to the mobile device 120).

Similarly, the trajectory of the mobile device 120 may be calculated based on data from inertial sensors (e.g., as described with respect to sensors 180) of the mobile device 120. In particular, the mobile device 120 may include an inertial measurement unit (IMU) that includes one or more sensors that measure force, angular rate, orientation, direction and the like. The sensors may include, for example, an accelerometer, a gyroscope, and a magnetometer. Changes to the calibrated pose of the camera 122 may be determined with inertial measurements from the IMU to estimate the current pose and location of the camera 122 in real time. For example, visual inertia odometry (VIO) or current odometry and mapping (OCM) may be used.

An error in the distance calculation accumulates over time and is also calculated. If the error calculation becomes greater than a threshold error, another method of measuring distance may need to be used. The method that is used may be selected based on lowest amount of error.

Referring to FIG. 2, the noise factor model 170 may include an input layer 200, one or more hidden layers 202, and an output layer 204. The values for the input layer 200 include image data 140 (e.g., image features) and data from sensors 180. The output layer 204 is the predicted noise factor.

The nodes 210 of the input layer 200 are the image data 140 and sensor data 180 and a bias node 212. The hidden layers 202 may have various numbers of “activation” nodes 220 and a bias node 222. The nodes 230 of the output layer are the labels that characterize each noise factor, for example, “snow,” “fog,” and “glare” (e.g., the noise factor model 170 predicts probability values for a set of noise factors).

Each node is connected to each node in the next layer and each connection has a weight such that each node in the hidden layer 202 is a weighted sum of each of the nodes in the previous layer (e.g., the first layer 200 or a hidden layer if additional hidden layers 202 are used). Each node has an activation function (e.g., a unit step) that determines a value (e.g., from zero to one) based on the weighed sum.

The input values of the first layer 200 are the image data 140 and the sensor data 180. The value at each node in each layer after the first layer is calculated by what may be referred to as a hypothesis function. The hypothesis function is the activation function applied to a weighted sum of the values of the previous layer of nodes (e.g., input values). The weighted sum is the values of the previous layer multiplied by weights between the nodes of the previous layer and the nodes of the current layer.

The activation function may be a sigmoid function with a range of values between zero and ogre. Because multiple output labels are used, the sigmoid function allows for different probabilities or levels of activation of a node and the model chooses the output label with the highest probability of fitting the image data 140 and sensor data 180. The bias node allows the activation function to shift or to change steepness.

A cost function represents the sum of the error (e.g., difference between the predicted value and the real value). The noise factor model 170 determines values for the weights that minimize the error of the cost function. For training and testing, images 140 and sensor data 180 that is labeled (i.e., known output values) are used. For example, if an image 140 and/or sensor data 180 is labeled as “snow,” the output values for the output layer 204 will be a value of one for “snow” and zero for the other noise factors.

The weights can be calculated with backpropagation methods using the images 140 and sensor data 180 that are labeled as training examples and for testing for accuracy.

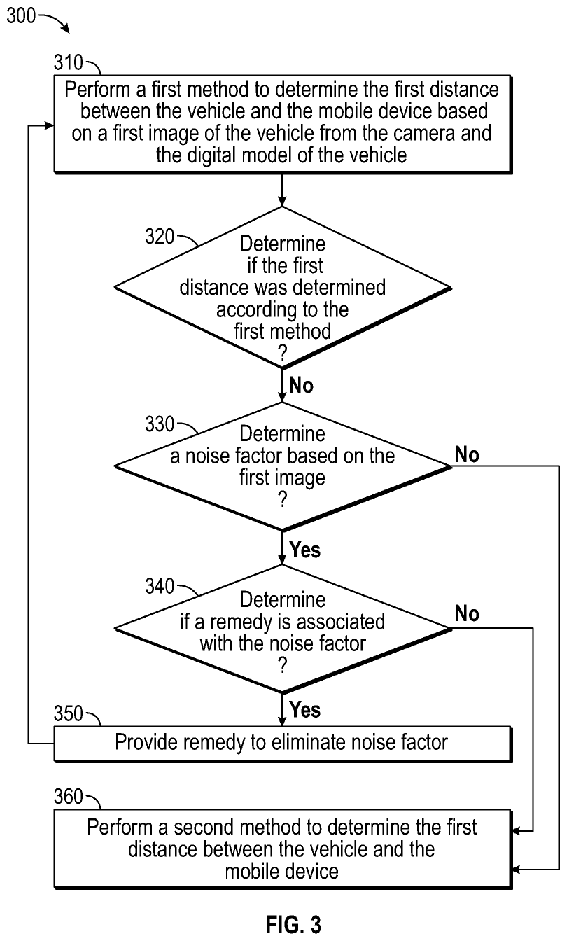

Referring to FIG. 3, the vehicle control system 110 may perform an exemplary method 300 of determining the distance 130. According to a first step 310 of the method 300, the vehicle control system 110 performs a first method to determine the first distance 130 between the vehicle 100 and the mobile device 120 based on a first image 140 of the vehicle 100 from the camera 122 and the digital model 142 of the vehicle 100.

According to a second step 320, the vehicle control system 110 determines if the distance 130 was determined according to the first method.

According to a third step 330 if the first distance 130 was not determined by the first method, the vehicle control system 110 determines a noise factor. For example, the noise factor is determined by the noise factor model 170 based on the first image 140.

According to a fourth step 340, the vehicle control system 110 determines if a remedy is associated with the determined noise factor.

According to a fifth step 350, if a remedy is associated with the determined noise factor, the vehicle control system 110 displays the remedy to be implemented by the user. The remedy includes an action for a user of the mobile device 120 to perform to remove the noise factor from the image 140 of the camera 122. For example, the action is displayed as text or symbolically on a user interface of the mobile device 120.

According to a sixth step 360, if a remedy is not associated with the determined noise factor the vehicle control system 110 performs a second method to determine the first distance 130 between the vehicle 100 and the mobile device 120.

Referring to FIG. 4, the vehicle control system 110 is described in greater detail.

The vehicle computer 112 includes computer components including a memory (e.g., memory 400) and a processor (e.g., a processor 402).

A processor ray be suitable processing device or set of processing devices such as, but not limited to: a microprocessor, a microcontroller-based platform, a suitable integrated circuit, one or more field programmable gate arrays (FPGAs), and/or one or more application-specific integrated circuits (ASICs).

A memory may be volatile memory (e.g., RAM, which can include non-volatile RAM, magnetic RAM, ferroelectric RAM, and any other suitable forms), on-volatile memory (e.g., disk memory, FLASH memory, EPROMs, EEPROMs, memristor-based non-volatile solid-state memory, etc.), unalterable memory (e.g., EPROMs), read-only memory, and/or high-capacity storage devices (e.g., hard drives, solid state drives, etc). In some examples, the memory includes multiple kinds of memory, particularly volatile memory and non-volatile memory.

Memory is computer readable media on which one or more sets of instructions, such as the software for performing the methods of the present disclosure, can be embedded. The instructions may embody one or more of the methods or logic as described herein. The instructions may reside completely, or at least partially, within any one or more of the memory, the computer readable medium, and/or within the processor during execution of the instructions.

The terms “non-transitory computer-readable medium” and “computer-readable medium” should be understood to include a single medium or multiple media, such as a centralized or distributed database, and/or associated caches and servers that store one or more sets of instructions. The terms “non-transitory computer-readable medium” and “computer-readable medium” also include any tangible medium that is capable of storing, encoding or carrying a set of instructions for execution by a processor or that cause a system to perform any one or more of the methods or operations disclosed herein. As used herein, the term “computer readable medium” is expressly defined to include any type of computer readable storage device and/or storage disk and to exclude propagating signals.

The vehicle 100 includes a vehicle control unit (VCU) 404, the VCU 404 includes a plurality of electronic control units (ECUs) 410 disposed in communication with the vehicle computer 112. The VCU 404 may coordinate the databetween vehicle systems, connected servers, and other vehicles operating as part of a vehicle fleet. The VCU 404 may control aspects of the vehicle 100, and implement one or more instruction sets (e.g., method 300) received from a vehicle system controller (such as vehicle computer 112).

The VCU 404 can include or communicate with any combination of the ECUs 410, such as, for example, a Body Control Module (BCM) 412, an Engine Control Module (ECM) 414, a Transmission Control Module (TCM) 416, the Telematics Control Unit (TCU) 418, a Restraint Control Module (RCM) 420, and the like. The TCU 418 may be disposed in communication with the ECUs 410 by way of a Controller Area Network (CAN) bus 440. In some aspects, the TCU 418 may retrieve data and send data as a CAN bus 440 node.

The CAN bus 440 may be configured as a multi-master serial bus standard for connecting two or more of the ECUs 410 as nodes using a message-based protocol that can be configured and/or programmed to allow the ECUs 410 to communicate with each other. The CAN bus 440 may be or include a high-speed CAN (which may have bit speeds up to 1 Mb/s on CAN, 5 Mb/s on CAN Flexible Data Rate (CAN FD)), and can include a low-speed or fault tolerant CAN (up to 125 Kbps), which may, in some configurations, use a linear bus configuration. In some aspects, the ECUs 410 may communicate with a host computer (e.g., the vehicle computer 112, server(s), etc.), and may also communicate with one another without the necessity of a host computer.

The CAN bus 440 may connect the ECUs 410 with the vehicle computer 112 such that the vehicle computer 112 may retrieve information from, send information to, and otherwise interact with the ECUs 410 to perform steps described according to embodiments of the present disclosure. The CAN bus 440 may connect CAN bus nodes (e.g., the ECUs 410) to each other through a two-wire bus, which may be a twisted pair having a nominal characteristic impedance. The CAN bus 440 may also be accomplished using other communication protocol solutions, such as Media Oriented Systems Transport (MOST) or Ethernet. In other aspects, the CAN bus 440 may be a wireless intra-vehicle CAN bus.

The VCU 404 may control various loads directly via the CAN bus 440 communication or implement such control in conjunction with the BCM 412. The ECUs 410 described with respect to the VCU 404 are provided for exemplary purposes only, and are not intended to be limiting or exclusive. Control and/or communication with other control modules is possible, and such control is contemplated.

The ECUs 410 may control aspects of vehicle operation and communication using inputs from human drivers, inputs from a vehicle system controller, and/or via wireless signal inputs received via wireless channel(s) from other connected devices. The ECUs 410, when configured as nodes in the CAN bus 440, may each include a central processing unit (CPU), a CAN controller, and/or a transceiver.

The TCU 418 can be configured to provide vehicle connectivity to wireless computing systems onboard and onboard the vehicle 100 and is configurable for wireless communication between the vehicle 100 and other systems, computers, servers, devices, and modules.

For example, the TCU 418 includes a Navigation (NAV) system 430 for receiving and processing a GPS signal from a UPS 432, a Bluetooth® Low-Energy Module (BLEM) 434, a Wi-Fi transceiver, an Ultra-Wide Band (UWB) transceiver, and/or other wireless transceivers described in further detail below for using near field communication (NFC) protocols, Bluetooth® protocols, Ultra-Wide Band (UVB), and other possible data connection d sharing techniques.

The TCU 418 may include wireless transmission and communication hardware that may be disposed in communication with one or more transceivers associated with telecommunications towers (e.g., cellular towers) and other wireless telecommunications infrastructure. For example, the BLEM 434 may be configured and/or programmed to receive messages from, and transmit messages to, one or more cellular towers associated with a telecommunication provider, and/or and a Telematics Service Delivery Network (SDN) associated with the vehicle 100 for coordinating vehicle fleet.

The BLEM 434 may establish wireless communication using Bluetooth® and Bluetooth Low-Energy® communication protocols by broadcasting and/or listening for broadcasts of small advertising packets, and establishing connections with responsive devices that, are configured according to embodiments described herein. For example, the BLEM 434 may include Generic Attribute Profile (GATT) device connectivity for client devices that respond to or initiate GATT commands and requests.

External servers (e.g., servers 442) may be communicatively coupled with the vehicle 100 and the mobile device 120 via one or more network(s) 452, which may communicate via one or more wireless channel(s) 450. The wireless channel(s) 450 are depicted in FIG. 4 as communicating via the one or more network(s) 452.

The mobile device 120 may be connected with the vehicle 100 via direct communication (e.g., channel 454) using near field communication (NFC) protocols, Bluetooth® protocols, Wi-Fi, Ultra-Wide Band (UWB), and other possible data connection and sharing techniques.

The network(s) 452 illustrate example communication infrastructure in which the connected devices discussed in various embodiments of this disclosure may communicate. The network(s) 452 may be and/or include the Internet, a private network, public network or other configuration that operates using any one or more known communication protocols such as, for example, transmission control protocol/Internet protocol (TCP/IP) Bluetooth®, based on the Institute of Electrical and Electronics Engineers (IEEE) standard 802.11, WiMAX (IEEE 802.16m), Ultra-Wide Band (UWB), and cellular technologies such as Time Division Multiple Access (TDMA), Code Division Multiple Access (CDMA), High Speed Packet Access (HSPDA), Long-Term Evolution (LTE), Global System for Mobile Communications (GSM), and Fifth Generation (5G), Universal Mobile Telecommunications System (UMTS), Long Term Evolution (LTE), and the like.

The NAV system 430 may be configured and/or programmed to determine the vehicle location. The NAV system 430 may include a Global Positioning System (GPS) receiver configured or programmed to triangulate the vehicle location relative to satellites or terrestrial based transmitter towers associated with the GPS 432.

The NAV system 430 may be further configured or programmed to develop routes from a current vehicle location to a selected destination, display a map and present directions to the selected destination, and determine an estimated time to travel to the selected location and a predicted time of arrival. The estimated time of arrival may be based on the position, speed, and heading or other vehicle information determined by the NAV system 430.

The BCM 412 generally includes an integration of sensors, vehicle performance indicators, and variable reactors associated with vehicle systems, and may include processor-based power distribution circuitry that can control functions associated with the vehicle body such as lights, windows, security, door locks and access control, and various comfort controls. The BCM 412 may also operate as a gateway for bus and network interfaces to interact with remote ECUs.

The BCM 412 may coordinate any one or more functions from a wide range of vehicle functionality, including energy management systems, alarms, vehicle immobilizers, driver and rider access authorization systems, Phone-as-a-Key (PaaK) systems, driver assistance systems, Autonomous Vehicle (AV) control systems, power windows, doors, actuators, and other functionality, etc. The BCM 412 may be configured for vehicle energy management exterior lighting control, wiper functionality, power window and door functionality, heating ventilation and air conditioning systems, and driver integration systems.

In other aspects, the BCM 412 may control auxiliary equipment functionality, and/or is responsible for integration of such functionality. In one aspect, a vehicle having a vehicle control system may integrate the system using, at least in part, the BCM 412. For example, the BCM 412 may be used to control vehicle systems according to the determined distance 130.

In the above disclosure, reference has been made to the accompanying drawings, which form a part hereof, which illustrate specific implementations in which the present disclosure may be practiced. It is understood that other implementations may be utilized, and structural changes may be made without departing from the scope of the present disclosure. References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a feature, structure, or characteristic is described in connection with an embodiment, one skilled in the art will recognize such feature, structure, or characteristic in connection with other embodiments whether or not explicitly described.

It should also be understood that the word “example” as used herein is intended to be non-exclusionary and non-limiting in nature. More particularly, the word “exemplary” as used herein indicates one among several examples, and it should be understood that no undue emphasis or preference is being directed to the particular example being described.

A computer-readable medium (also referred to as a processor-readable medium) includes any non-transitory (e.g., tangible) medium that participates in providing data (e.g., instructions) that may be read by a computer e.g., by a processor of a computer). Such a medium may take many forms, including, but not limited to, non-volatile media and volatile media. Computing devices may include computer-executable instructions, where the instructions may be executable by one or more computing devices such as those listed above and stored on a computer-readable medium.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating various embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary. Conditional language, such as, among others, “can,” “could,” “might,” or “may,” unless specifically stated otherwise, or otherwise understood within the context as used, is generally intended to convey that certain embodiments could include, while other embodiments may not include, certain features, elements, and/or steps. Thus, such conditional language is not generally intended to imply that features, elements, and/or steps are in any way required for one or more embodiments

What is claimed is:

1. A system, comprising:
a vehicle;
a mobile device comprising a camera;
a digital model of the vehicle; and
a processor and a memory comprising instructions that, when executed by the processor, are configured to cause the processor to:
performing a first method to determine a first distance between the vehicle and the mobile device based on a first image of the vehicle from the camera and the digital model of the vehicle; and
determine, if the first distance is unable to be determined by the first method, a noise factor.

2. The system of claim 1, wherein the instructions comprise comparing the first distance to a threshold distance.

3. The system of claim 2, wherein the instructions comprise disabling control of the vehicle with the mobile device if the first distance is greater than the threshold distance.

4. The system of claim 1, wherein the first distance is determined during a remote parking procedure.

5. The system of claim 1, wherein the vehicle is configured to transmit the digital model of the vehicle to the mobile device.

6. The system of claim 1, wherein the noise factor includes at least one of snow on the vehicle, reflection of light off the vehicle at a lens of the camera, active rain fall, fog, and/or low natural light.

7. The system of claim 1, wherein the noise factor is determined according to a noise factor model.

8. The system of claim 7, wherein the noise factor model is a machine learning model that is configured to determine a probability for each of a plurality of noise factors.

9. The system of claim 8, wherein the noise factor model is trained on a plurality of images that, are labeled with a noise factor classification.

10. The system of claim 8, wherein the noise factor model is trained on sensor data from vehicle sensors.

11. The system of claim 10, wherein the vehicle sensors include at least one of a vehicle camera, a global positioning system (GPS) a temperature sensor, and a barometer.

12. The system of claim 8, wherein the noise factor model is trained on data collected by the vehicle including weather data from weather stations.

13. The system of claim 1, wherein the instructions comprise determining if a remedy is associated with the noise factor, wherein the remedy comprises an action for a user of the mobile device to perform to remove the noise factor from the first image.

14. The system of claim 13, wherein the instructions comprise displaying, if the remedy is associated with the noise factor, the remedy on a user interface of the mobile device.

15. The system of claim 14, wherein the instructions comprise performing the first method to determine the first distance between the vehicle and the mobile device based. on a second image of the vehicle from the camera and the digital model of the vehicle.

16. The system of claim 13, wherein the instructions comprise, if the noise factor is not associated with the remedy, performing a second method to determine the first distance between the vehicle and the mobile device.

17. The system of claim 16, wherein the second method is based on at least one of an image from a vehicle camera, a strength of a wireless connection between the vehicle and the mobile device, triangulating signals from low frequency (LF) antennas, and/or calculating a trajectory of the vehicle and a trajectory of the mobile device.

18. A method, comprising:
performing a first method to determine a first distance between a vehicle and a mobile device based on a first image of the vehicle from a camera of the mobile device and a digital model of the vehicle;
determining if the first distance was determined according to the first method;
determining, if the first distance was not determined by the first method, a noise factor;
determining if a remedy is associated with the noise factor, wherein the remedy comprises an action for a user of the mobile device to perform to remove the noise factor from the first mage; and
performing, if the noise factor is not associated with the remedy, a second method to determine the first distance between the vehicle and the mobile device.

19. The method of claim 18, wherein the noise factor is determined by a noise factor model.

20. The method of claim 18, further comprising displaying, if the noise factor is associated with the remedy, the remedy on a user interface of the mobile device.
